(19) United States
(12) Patent Application Publication
(10) Pub. No.: US 2013/0329919 A1
(43) Pub. Date: Dec. 12, 2013

(54) Portable electronic device with bone conduction speaker

(71) Applicant: Jing He, Shenzhen (CN)

(72) Inventor: Jing He, Shenzhen (CN)

(73) Assignees: AAC MICROTECH (CHANGZHOU) CO.,LTD., Changzhou (CN); AAC ACOUSTIC TECHNOLOGIES (SHENZHEN) CO., LTD., Shenzhen (CN)

(21) Appl. No.: 13/902,733

(22) Filed: May 24, 2013

(30) Foreign Application Priority Data
Jun. 8, 2012 (CN) 201220271021.3

(51) Int. Cl. H04R 1/46

(52) U.S. Cl. CPC H04R 1/46
USPC 381/151

(57) ABSTRACT

Disclosed is a portable electronic device. The portable electronic device includes a main board and a bone conduction speaker electrically coupled with the main board. When the portable electronic device is used in a high-noise environment, the main board drives the bone conduction speaker for enabling its user to perceive the sound wave.

### FIELD OF THE INVENTION

The present invention generally relates to a portable electronic device, and more particularly, to an portable electronic device with a bone conduction speaker.

### DESCRIPTION OF RELATED ART

Air ordinary speakers are widely used in many types of portable electronic devices, such as mobile phones, notebook computers, and hearing aids, for converting audio electrical signals to audible sounds. As widely known, the audible sounds producing from the air ordinary speaker is transferred by air and then listened by a user. This is why this kind of speaker is called air ordinary speaker.

When a portable electronic device with the air ordinary speaker, related to the present invention, is used in a high-noise environment, the user is not able to perceive audible sounds producing from the air ordinary speaker. In order to solve this problem, the user should improve the sound level of the audible sounds, which makes the people around him/her uncomfortable.

### BRIEF DESCRIPTION OF THE DRAWINGS

FIG. 1 is an illustrative assembled view of a portable electronic device assembled with a bone conduction speaker in accordance with an exemplary embodiment of the present disclosure.

FIG. 2 is an illustrative cross-sectional view of the portable electronic device in FIG. 1.

FIG. 3 is an illustrative enlarged view of part A in FIG. 2.

### DETAILED DESCRIPTION OF THE EXEMPALRY EMBODIMENT

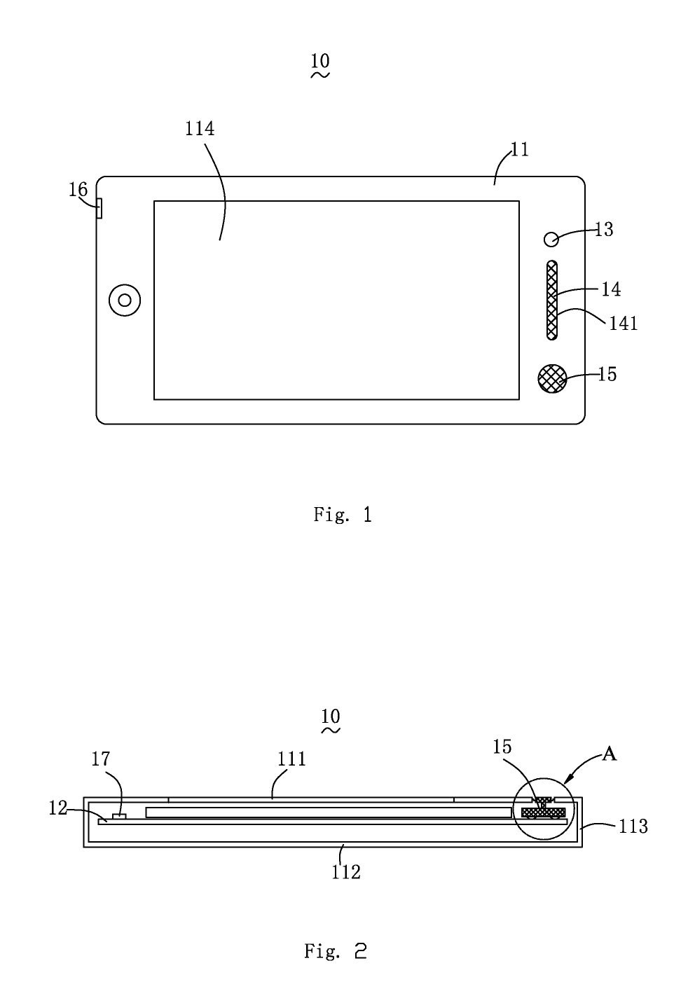

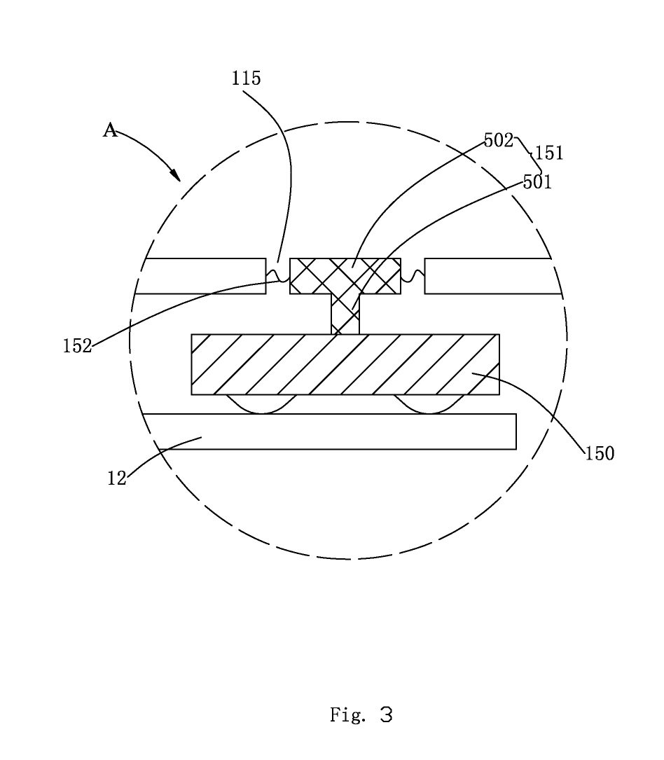

Referring to FIGS. 1 to 3, a portable electronic device 10 assembled with a bone conduction speaker 15, in accordance with a exemplary embodiment of the present disclosure, comprises a housing 11, and a main board 12 accommodated in the housing 11. When the portable electronic device serves as a mobile phone or other portable consumer product, it may optionally include a camera 13, a microphone 16, and an air ordinary speaker 14 electrically coupled to the mainboard 12, respectively. The portable electronic device 10 further includes a comparator 17 electrically coupled with the main board 12. The camera 13, the microphone 16, the air ordinary speaker 14, the bone conduction speaker 15 and the comparator 17 are all received in the housing 11.

The microphone 16 is communicated with the outside of the housing 11 for catching environmental noise signals and sending the environmental noise signals to the main board 12. The main board 12 may provides a first driving signal for driving the air ordinary speaker 14, a second driving signal for driving the bone conduction speaker 15. The air ordinary speaker 14 receives the first driving signal supplied from the main board 12 and converts the first driving signal into audible sounds which is transferred by air and then listened to by the user.

The housing 11 has an upper cover 111, a bottom cover 112 opposite to the upper cover 111, and a sidewall 113 connecting with the upper cover 111 and the bottom cover 112. The upper cover 111 has a center receiving room 114 for receiving a display screen, a first acoustic aperture 141 drilled completely through the upper cover and spaced from the center receiving room 114 for transferring audible sounds produced from the air ordinary speaker 14, and a second acoustic aperture 115 drilled completely through the upper cover 111 and spaced from the center receiving room 114 for receiving at least a part of the bone conduction speaker 15.

The bone conduction speaker 15 softly contacts with the user and receives the second driving signal supplied from the main board 12 for converting the second driving signal into vibration which is transferred directly to the user's body and then is recognized by the user's hearing organ as sounds, not via the air. The bone conduction speaker 15 has a bone conduction body 150 mounted on the main board 12 for producing vibration, a radiating portion 151 connected with the bone conduction body 150 and accommodated in the second acoustic aperture 115, and at least one suspension 152 elastically connecting a sidewall of the second acoustic aperture 115 with the radiating potion 151 for providing a soft contact between the user and the bone conduction speaker 15. In order to transfer the sound, i.e., the vibration provided by the bone conduction speaker to the user rapidly, the bone conduction speaker contacts with the user's forehead, temple, cheekbone or an area between the user's eyes.

The radiating potion 151 has a radiating plate 502 exposed out of the second acoustic aperture 115 and softly contacts with the user and an extending portion 501 extending from the radiating plate 502 and connecting with the bone conduction body 150 for transferring the vibration to the radiating plate 502. In order to transfer the vibration to the user rapidly, the extending portion 501 is perpendicular to the bone conduction body 150. In this embodiment, the bone conduction speaker 15 has a pair of suspensions 152 for supporting the radiating portion 151 in the second acoustic aperture 115 stably. In alternative embodiment, the radiating portion and the suspension are all omitted. At least a part of the bone conduction body is directly exposed out of the second acoustic aperture for directly connecting with the user's hearing organ.

The portable electronic device 10 further has a comparator 17 electrically coupled with the main board 12 for receiving the environmental noise signals supplied from the main board 12. The comparator 17 has a predetermined critical value and is capable of comparing the predetermined critical value with the environmental noise signals values and sending the result to the main board 12. When the main board 12 receives a result that the predetermined critical value is smaller than or equal to the environmental noise signal value, the main board 12 sends the second driving signal to the bone conduction speaker 15 and the portable electronic device works at a first mode. On the contrary, when the main board receives another result that the predetermined critical value is greater than the environmental noise signal, the main board sends the first driving signal to the air ordinary speaker and the portable electronic device works at a second mode.

When the portable electronic device works at the first mode, the device enables its user to perceive the sound wave in a high-noise environment by means of the transmission of the bone conduction speaker without making the people around him/her uncomfortable. In other words, the portable electronic device allows the user to listen to the device sufficiently and clearly in a noisy place so that the user can make a call without disturbing the people nearby in the crowd.

While the present invention has been described with reference to the specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A portable electronic device comprising:
a housing;
a main board accommodated in the housing;
a microphone mounted in the housing for catching environmental noise signals and sending the environmental noise signals to the main board;
an air ordinary speaker electrically coupled with the main board for receiving a first driving signal supplied from the main board and converting the first driving signal into sound wave which is transferred by air;
a bone conduction speaker electrically coupled with the main board for receiving a second driving signal supplied from the main board and converting the second driving signal into sound which is transferred by vibrations directly applied on a user's body and is captured by the user's hearing organ; and
a comparator having a predetermined critical value and electrically coupled with the main board for comparing the predetermined critical value with values of the environmental noise signals supplied from the main board and sending results to the main board;
wherein, when the main board receives a result that the predetermined critical value is greater than the environmental noise signal value, the main board sends the first driving signal to the air ordinary speaker; when the main board receives a result that the predetermined critical value is smaller than or equal to the environmental noise signal value, the main board sends the second driving signal to the bone conduction speaker.

2. The portable electronic device as described in claim 1, wherein the bone conduction speaker further has a bone conduction body mounted on the main board for producing vibration, a radiating portion connected with the bone conduction body and softly contacting with the user, and at least a suspension elastically connecting the radiating potion with the housing for providing a soft contact between the user and the bone conduction speaker.

3. The portable electronic device as described in claim 2, wherein the radiating potion has a radiating plate softly contacting with the user and an extending portion extending from the radiating plate and connecting with the bone conduction body for transferring the vibration to the radiating plate.

4. The portable electronic device as described in claim 3, wherein the extending portion is perpendicular to the bone conduction body for transferring the vibration to user rapidly.

5. The portable electronic device as described in claim 1, wherein the housing has an upper cover, a bottom cover opposite to the upper cover, and a sidewall connecting with the upper cover and the bottom cover, the upper cover has a center receiving room for receiving a display screen, a first acoustic aperture drilled completely through the upper cover and spaced from the center receiving room for transferring audible sounds produced from the air ordinary speaker, and a second acoustic aperture drilled completely through the upper cover and spaced from the center receiving room for receiving at least a part of the bone conduction speaker.
